(19) United States
(12) Patent Application Publication
(10) Pub. No.: US 2006/0172762 A1
(43) Pub. Date: Aug. 3, 2006

(54) Network assisted repudiation and auditing for content created using wireless devices

(75) Inventors: Debashish Purkayastha, Pottstown, PA (US); John Thommana, Cedar Rapids, IA (US); Alain Charles Louis Briancon, Poolesville, MD (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/263,290

(22) Filed: Oct. 31, 2005

Related U.S. Application Data
(60) Provisional application No. 60/630,871, filed on Nov. 24, 2004.

(51) Int. Cl. H04M 1/00

(52) U.S. Cl. 455/550.1

(57) ABSTRACT

A method for tracking content objects created on a wireless device in a wireless communication system begins by creating a content object at the wireless device. A content creation request message is sent from the wireless device to an information storage entity (ISE). The ISE determines whether any permissions are required to create the content object. A content creation response message is sent from the ISE to the wireless device, the content creation response message including an identification key specific to the content object. The identification key is embedded into the content object by the wireless device.

### CROSS REFERENCE TO RELATED APPLICATION(S)

This application claims the benefit of U.S. Provisional Application No. 60/630,871, filed Nov. 24, 2004, which is incorporated by reference as if fully set forth herein.

### FIELD OF INVENTION

The present invention relates generally to security for content created with a wireless device, and more particularly, to a method and system for using a network assisted method of repudiation and auditing to control such content.

### BACKGROUND

Advancements in technology have improved miniaturization technology to a sufficient level that devices that were once considered standalone have now been aggregated. For example, cameras and microphones that were once considered standalone are now being integrated into cellular phones and other wireless devices, permitting users to create multimedia content with their wireless device.

The absence of content-related security mechanisms makes it difficult to track an offender when an attempt is made to violate ownership rights in the content and make unauthorized use of the content for personal gain without the content owner's consent.

### SUMMARY

The present invention proposes a method and system to establish ownership of the products of these embedded recording devices. It assists in tracking and identifying the owner of the recorded/sensed element and in settling future disputes, if any arise out of unauthorized use of the content. The present invention solves the problem of “Repudiation and Auditing” by inserting a hidden key with assistance from the network, utilizing a signaling-based approach.

A method for tracking content objects created on a wireless device in a wireless communication system begins by creating a content object at the wireless device. A content creation request message is sent from the wireless device to an information storage entity (ISE). The ISE determines whether any permissions are required to create the content object. A content creation response message is sent from the ISE to the wireless device, the content creation response message including an identification key specific to the content object. The identification key is embedded into the content object by the wireless device.

A method for requesting permission to modify an existing content object to create a new content object by a device begins by sending a content modification intention message from the device to an ISE containing information regarding the existing content object. The content modification intention is compared to modification preferences of the existing content object by the ISE. A modification permission is created based on the result of the comparing step. A content modification response message is sent from the ISE to the device, the content modification response message including the modification permission. The existing content object is modified to create the new content object if the modification permission is granted.

A system for tracking content objects created on a wireless device in a wireless communication system includes a base station, an ISE, and at least one identification key. The base station is configured to enable the wireless device to communicate with the wireless communication system. The ISE communicates with the base station, and the ISE is configured to track content objects. The identification keys used by the ISE to track content objects, one identification key being associated with each content object.

A handset for creating and tracking content objects includes a multimedia creation device, a location identification device, a field of usage device, a content creation request device, and an embedding device. The multimedia creation device is configured to create a content object. The location identification device is configured to identify the present geographic location of the handset. The field of usage device is configured to create a field of usage based on capabilities of the multimedia creation device. The content creation request device is configured to exchange messages with an information storage entity location on a wireless network with which the handset communicates and configured to receive an identification key from the information storage entity. The embedding device is configured to embed the identification key in the content object.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a block diagram of a system for repudiation and auditing of content;

FIG. 2 is a flowchart of a method for repudiation and auditing of content created on a wireless device;

FIG. 3 is a flowchart of a method for determining whether an object is permitted to be modified during creation of another object;

FIG. 4 is a flow diagram of system exchanging messages using the methods shown in FIGS. 2 and 3;

FIG. 5 is a diagram of an object created using the method shown in FIG. 2; and

FIG. 6 is a block diagram of a handset configured for repudiating and auditing of content, the handset interacting with a network.

### DETAILED DESCRIPTION OF THE PREFERRED EMBODIMENTS

Hereafter, the term “wireless transmit/receive unit” (WTRU) includes, but is not limited to, a user equipment, a mobile station, a fixed or mobile subscriber unit, a pager, or any other type of device capable of operating in a wireless environment. When referred to hereafter, the term “base station” includes, but is not limited to, a Node B, a site controller, an access point, or any other type of interfacing device in a wireless environment. While the present invention is described in terms of a cellular phone, it is noted that any type of wireless device with similar multimedia features may be utilized without affecting the operation of the invention.

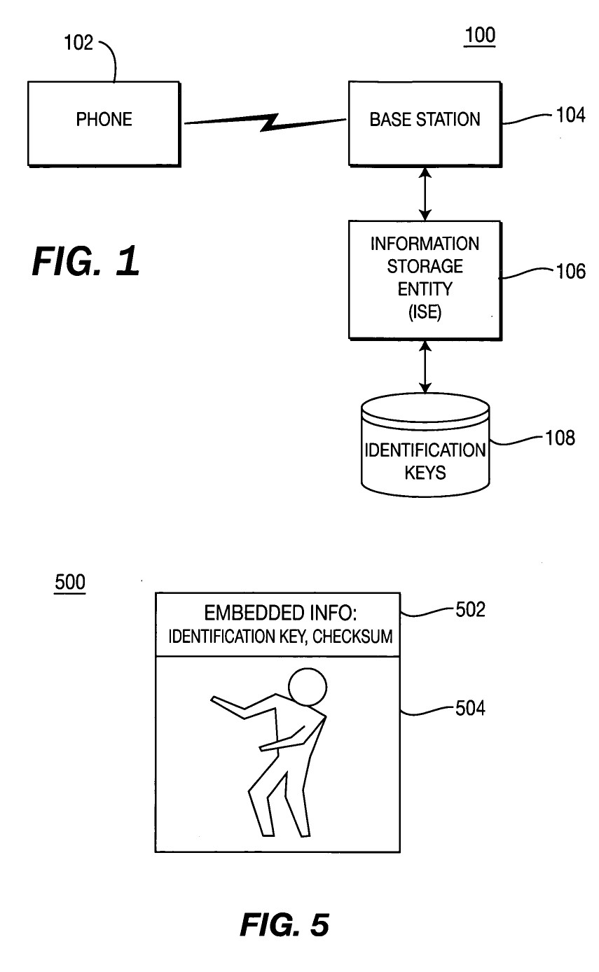

FIG. 1 is a block diagram of a system 100 for repudiation and auditing of content. The system 100 includes a cellular phone 102, a base station 104, an Information Storage Entity (ISE) 106 associated with the base station 104, and a database 108 associated with the ISE 106. The database 108 contains Identification Keys for identifying content. While the ISE 106 is shown in FIG. 1 as a separate entity, the ISE is a logical entity and can be located in different parts of the network, as known to one skilled in the art. For example, the ISE 106 may be located in the base station 104, in a home location register/visitor location register controlled by the network operator, or in an external entity accessible by established and open APIs.

An Identification Key in the ISE is used to track the contents. The ISE maintains a tree structure with each node being identified by the Identification Key. The numbering scheme for the keys is such that it is easy to identify the nodes in the tree, and may be partitioned as server ID, tree ID, etc. The Identification Key has all the information required to identify the ISE and the actual information. It is noted that the use of a tree structure is merely exemplary and that one skilled in the art can implement various data structures in which an Identification Key may be easily located.

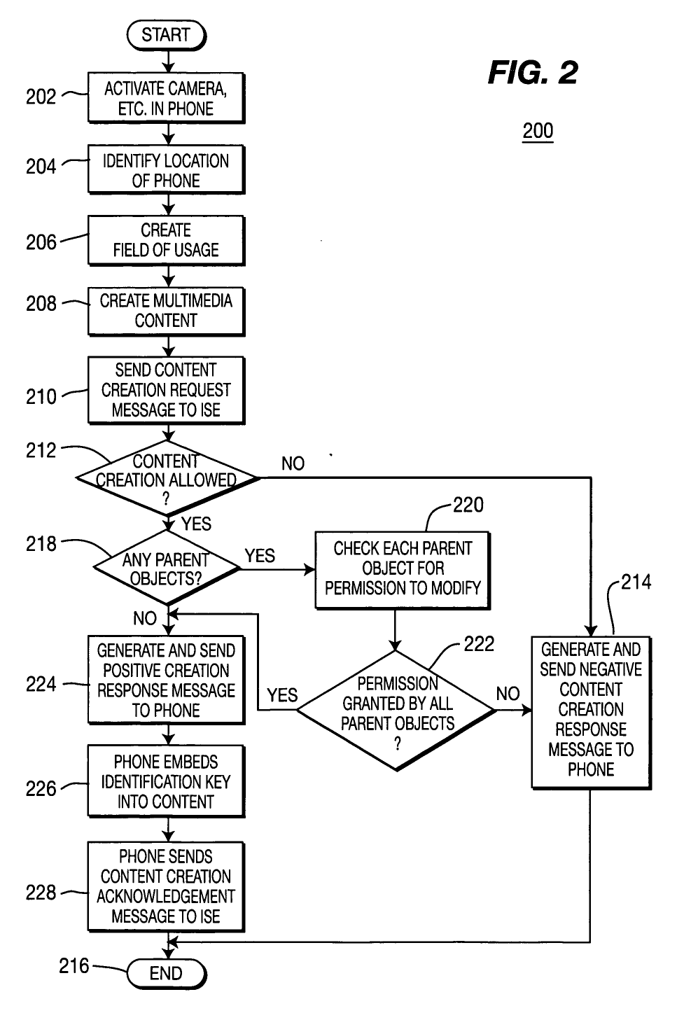

FIG. 2 is a flowchart of a method 200 for repudiation and auditing of content created on a wireless device. A camera or other multimedia creation device in the phone is activated (step 202). Once the multimedia creation device is activated, the phone identifies its geographic location (step 204). Based on the capabilities of the multimedia creation device being used, the phone creates a Field of Usage (FOU) for the device (step 206). The creation of the FOU marks the location boundary in terms of position coordinates. The capabilities of the multimedia creation device, such as a zoom range of a camera lens or a sensitivity range of a microphone, can be used in determining the FOU.

Based on the geographic location coordinates of the phone, the multimedia creation device determines the FOU relative to those coordinates. For example, if the phone is located at coordinates X, Y, the focusing mechanism of a camera determines that a photograph can be taken to a distance of Z feet away and at an angle of view based on the lens capabilities of the camera. The end result is that the FOU is a data structure including the geographic location coordinates, distance of the field, angle of the field, etc. In one embodiment, the FOU may be expressed in an XML schema. It is noted that one skilled in the art can readily envision other data structures to contain the same information.

The multimedia content is created at the phone (step 208) and the phone sends a content creation request message to the ISE associated with the base station that the phone currently communicates with (step 210). The content creation request message includes: a user identification field, a device identification field, a date and time field, the FOU for the phone, a request identifier, a number of parent objects [N], and parent Identification Key list [N]. The date and time field provides information about when the content was created, and is used as metadata associated with the content for auditing purposes. The request identifier can be any type of identifier (e.g., a serial number) used to identify the transaction initiated by the multimedia creation device.

The ISE examines the content creation request to determine if the content creation will be allowed (step 212). The ISE evaluates the information in the content creation request and the current electronic “do not disturb” zones in the vicinity to determine whether the multimedia creation device will be permitted to operate. The electronic “do not disturb” zones relate to the subject being recorded by the multimedia creation device. The subject can be a person, a building, or any other kind of object. For example, a user could define an area around themselves as a “do not disturb” zone. Within this zone, no camera or voice recorded can record the picture or voice of the zone's creator. The ability to create such a “do not disturb” zone may be subscription based and provided by a network operator. A user may request the network to create such a zone by providing the radius of the zone and the geographic coordinates of the requester. The network analyzes the FOU sent by the recording device and the “do not disturb” zone sent by the subject being recorded, in order to determine whether to grant permission to record the subject. Depending on the permissions, the multimedia creation device can be operated in that area.

If the content creation is not allowed, the ISE generates and sends a negative content creation response message to the phone (step 214) and the method terminates (step 216).

If the content creation is allowed (step 212), the ISE determines if the created multimedia object has any parent objects (step 218). New content may be created by cutting and pasting content from already existing content. In such cases, the Identification Key for all parent objects has to be provided. If the multimedia object has parent objects, then the ISE associated with each parent object (if different ISEs are involved) is checked for permission to modify that object to create the new multimedia object (step 220). The ISE then determines if permission to modify has been granted by all of the parent objects (step 222). If all of the parent objects do not grant permission to modify, then the ISE generates and sends a negative content creation response message to the phone (step 214) and the method terminates (step 216).

If the new multimedia object does not have any parent objects (i.e., it is an original multimedia object) (step 218) or if all of the parent objects grant permission to modify (step 222), then the ISE generates and sends a positive content creation response message to the phone (step 224). The content creation response message includes the request identifier and an Identification Key. The Identification Key is a master identifier which is used to identify content created by a user, the device used to create the content, and in a specific FOU, such that the Identification Key connects these pieces of data together. The ISE also stores a telephone number, IP address, or some other form of contact information so that subsequent manipulations of the content can be reported.

The phone embeds the Identification Key contained in the response message into the multimedia object along with a checksum (step 226). The checksum is computed in such a way that any manipulations of the content will cause it to fail. The checksum may be any type of checksum, such as a cyclic redundancy check (CRC). The checksum is only used for an integrity check; the phone would calculate the checksum and send it to the network for an integrity check in the case of auditing and repudiation. At the time of the integrity check, the network can compare the checksum sent by the phone to the checksum stored on the network.

The phone then sends a content creation acknowledgement message to the ISE (step 228) and the method terminates (step 216). The content creation acknowledgement message includes the Identification Key, a permission indicator, the checksum, and the request identifier. The ISE stores this information along with the other information provided by the user in the content creation request message.

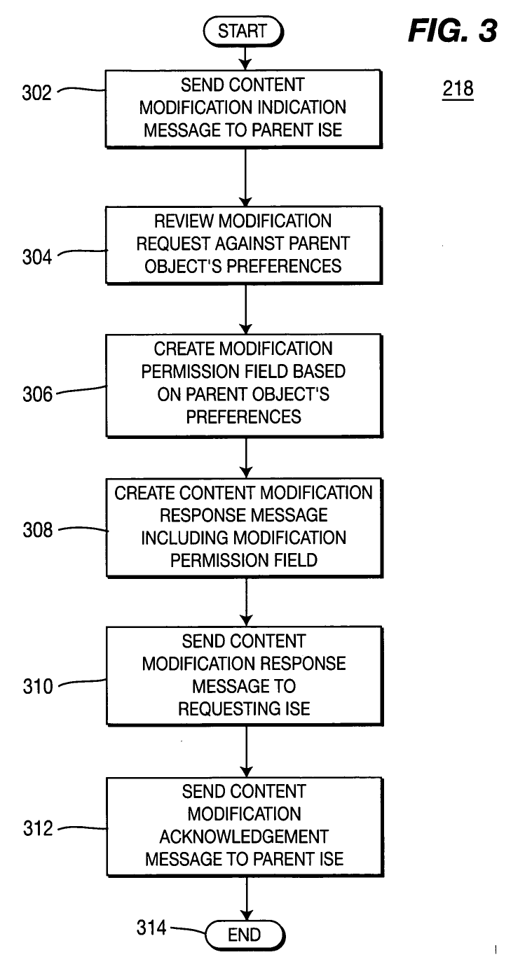

FIG. 3 is a flowchart of a method showing detail of step 218 from the method 200, in which each parent object is checked to determine whether permission to modify the parent object is granted. Whenever content is modified, the modifying entity parses the contact information field embedded in the content. The method begins by sending a content modification indication message to the ISE that hosts the parent object (step 302). The content modification indication message includes: the Identification Key of the object to be modified, the user identification, the device identification, the number of parent objects of the object to be modified [N], a parent Identification Key list [N], a date and time field, and a request identifier.

The parent ISE compares the modification request against the parent object's modification preferences stored at the parent ISE (step 304). Different permission levels may be granted to different levels of users, at the discretion of the object owner.

A modification permission field is created by the parent ISE based on the parent object's modification preferences (step 306). The parent ISE creates a content modification response message including the modification permission field, the request identifier, and the Identification Key (step 308). The content modification response message is sent to the requesting ISE (step 310). The requesting ISE sends a content modification acknowledgement message to the parent ISE (step 312) and the method terminates (step 314). The content modification acknowledgement message includes: the request identifier, the Identification Key, the new modification permission, a new checksum, and a date and time field.

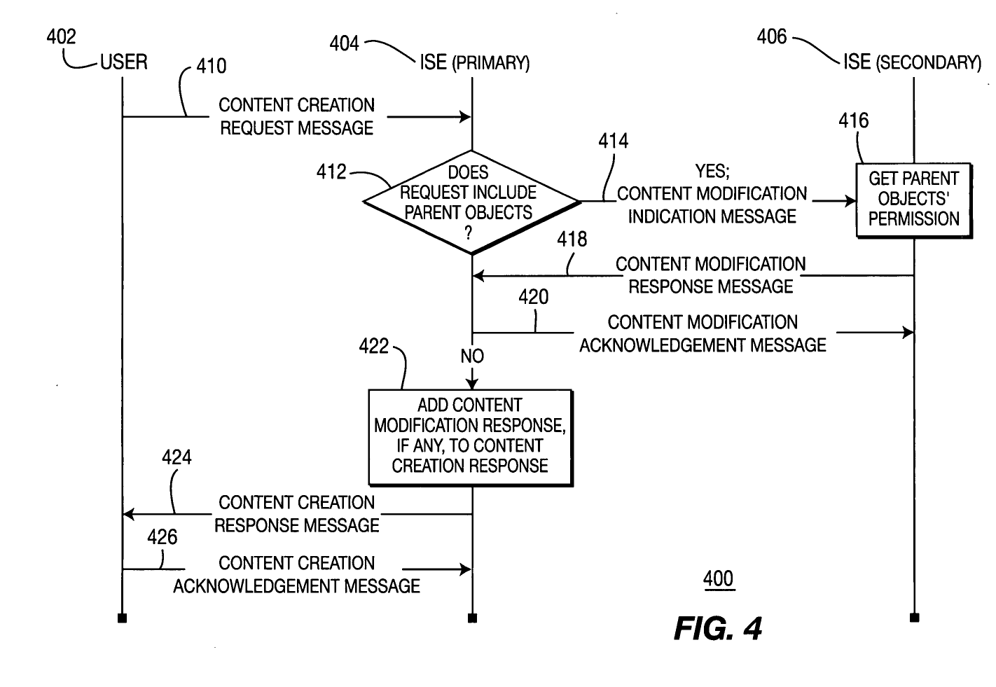

FIG. 4 is a flow diagram of a system 400 exchanging messages using the methods shown in FIGS. 2 and 3. The system 400 includes a user 402, a primary ISE 404, and a secondary ISE 406. The user 402 sends a content creation request message 410 to the primary ISE 404. The primary ISE 404 determines whether the multimedia object identified in the request message includes any parent objects (step 412). If the multimedia object includes parent objects, then the primary ISE 404 sends a content modification indication message 414 to the secondary ISE 406. The secondary ISE 406 obtains the permission to modify from each of the parent objects (step 416). The secondary ISE 406 sends a content modification response message 418 to the primary ISE 404. The primary ISE 404 replies by sending a content modification acknowledgement message 420 to the secondary ISE 406.

If the multimedia object does not include any parent objects or after receipt of the content modification acknowledgement message 420, the primary ISE 404 add the content modification response (if any) to a content creation response message (step 422). The content creation response message 424 is sent to the user, and replies by sending a content creation acknowledgement message 426.

FIG. 5 is a diagram of an object 500 created using the method shown in FIG. 2. The object 500 includes embedded information 502, including the Identification Key and the checksum, and the multimedia content 504. The embedded information 502 is not visible to the user and does not obscure or otherwise interfere with the display of the multimedia content 504.

A goal of this auditing and repudiation method is to maintain a modification and ownership trail with the content originator's ISE. As long as the appropriate information is available, the modification chain can be deduced and a rights violation can be identified.

Different service providers may contract out the functionality of the ISE to different vendors. This will necessitate inter-working among different ISEs to ensure wider coverage. Thus, some of the messages exchanged between a device and its ISE (especially the content modification messages) may be forwarded to other ISEs and clearance from all of these ISEs will be necessary to obtain a modification permission. This phase is necessary because users who created content with a different ISE may copy a part of content created with a different ISE.

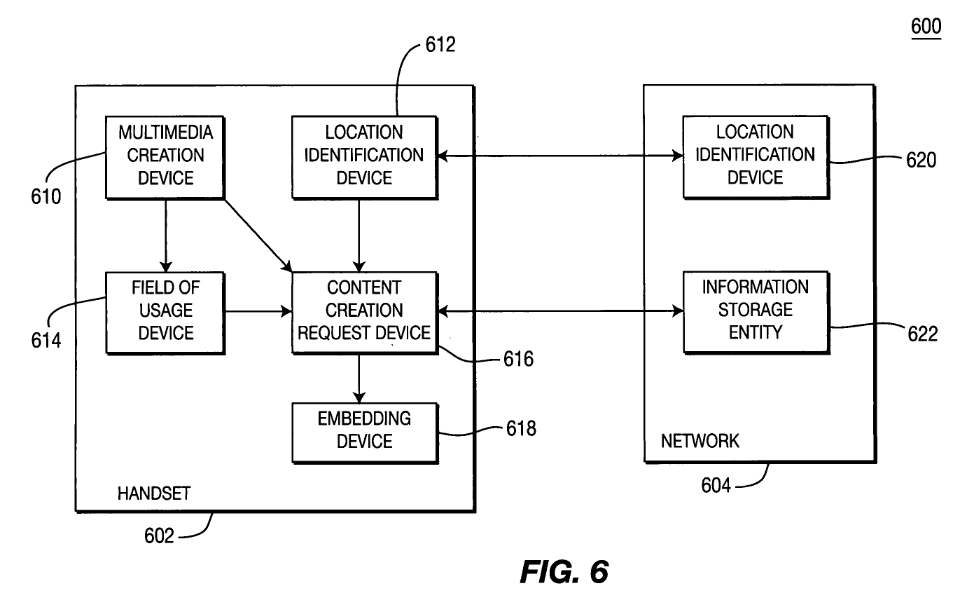

FIG. 6 is a diagram of a system 600, including a handset 602 and a network 604. The handset 602 includes a multimedia creation device 610, a location identification device 612, a FOU device 614, a content creation request device 616, and an embedding device 618. The network includes a location identification device 620 and an ISE 622.

In operation, the multimedia creation device 610 creates a content object. The location identification device 612 determines the geographic location of the handset 602, and if necessary, contacts the location identification device 620 in the network 604 for assistance in determining the geographic location. The FOU device 614 determines the FOU of the multimedia creation device 610. The content creation request device 616 takes the content object from the multimedia creation device 610, the geographic location information of the handset 602 from the location identification device 612, and the FOU from the FOU device 614 and assembles a content creation request message which is sent to the ISE 622. The ISE 622 determines whether the content object can be created, and if so, assigned an Identification Key to the content object, which is sent from the ISE 622 to the content creation request device 616. The embedding device 618 takes the content object and the Identification Key from the content creation request device 618 and embeds the Identification Key into the content object.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for tracking content objects created on a wireless device in a wireless communication system, comprising the steps of:
creating a content object at the wireless device;
sending a content creation request message from the wireless device to an information storage entity (ISE);
determining by the ISE whether any permissions are required to create the content object;
sending a content creation response message from the ISE to the wireless device, the content creation response message including an identification key specific to the content object; and
embedding the identification key into the content object by the wireless device.

2. The method according to claim 1, further comprising the step of:
determining whether the content object is permitted to be created by the wireless device, this determination being made by the ISE upon receipt of the content creation request message.

3. The method according to claim 2, wherein if the content object is not permitted to be created by the wireless device, the ISE sends a negative content creation response message to the wireless device and the method terminates.

4. The method according to claim 1, further comprising the steps of:
identifying the location of the wireless device; and
creating a field of usage based on the capabilities of the wireless device, wherein the identification key is based in part on the location of the wireless device and the field of usage.

5. The method according to claim 4, wherein the wireless device includes a camera and the field of usage is based on a zoom range of the camera lens.

6. The method according to claim 4, wherein the wireless device includes a microphone and the field of usage is based on a sensitivity range of the microphone.

7. The method according to claim 1, wherein the content creation request message includes information to identify the content object.

8. The method according to claim 7, wherein the information includes at least one item selected from the group consisting of: identification of a user of the wireless device, identification of the wireless device, a timestamp relating to the content object, and a request identifier.

9. The method according to claim 1, wherein the determining step includes:
determining whether the content object has any parent objects;
examining a modification permission for each parent object; and
allowing creation of the content object only if each parent object grants modification permission.

10. The method according to claim 1, further comprising the step of:
generating a checksum at the wireless device, the checksum based on the identification key received from the ISE.

11. The method according to claim 10, wherein the embedding step includes embedding the checksum into the content object by the wireless device.

12. The method according to claim 1, further comprising the step of:
sending a content creation acknowledgement message from the wireless device to the ISE, the content creation acknowledgement message being sent after the embedding step.

13. The method according to claim 12, wherein the content creation acknowledgement message includes the request identification for the content object and the identification key of the content object.

14. A method for requesting permission to modify an existing content object to create a new content object by a device, the method comprising the steps of:
sending a content modification intention message from the device to an information storage entity (ISE) containing information regarding the existing content object;
comparing the content modification intention to modification preferences of the existing content object by the ISE;
creating a modification permission based on the result of the comparing step;
sending a content modification response message from the ISE to the device, the content modification response message including the modification permission; and
modifying the existing content object to create the new content object if the modification permission is granted.

15. The method according to claim 14, wherein the content modification indication message includes information to identify the existing content object.

16. The method according to claim 15, wherein the information includes an identification key for the existing content object.

17. The method according to claim 14, wherein if a new content object includes multiple existing content objects, modification permission for each existing content object must be obtained before the new content object can be created.

18. The method according to claim 14, further comprising the step of:
sending a content modification acknowledgement message from the device to the ISE, the content modification acknowledgement message being sent after the content modification response message has been received by the device.

19. A system for tracking content objects created on a wireless device in a wireless communication system, comprising:
a base station configured to enable the wireless device to communicate with the wireless communication system;
an information storage entity (ISE) communicating with said base station, said ISE configured to track content objects; and
at least one identification key used by said ISE to track content objects, an identification key being associated with each content object.

20. A handset for creating and tracking content objects, comprising:
a multimedia creation device, configured to create a content object;
a location identification device, configured to identify the present geographic location of the handset;
a field of usage device, configured to create a field of usage based on capabilities of said multimedia creation device;
a content creation request device, configured to exchange messages with an information storage entity location on a wireless network with which the handset communicates and configured to receive an identification key from the information storage entity; and
an embedding device, configured to embed the identification key in the content object.

21. The handset according to claim 20, wherein the network includes a second location identification device configured to assist said location identification device to identify the present geographic location of the handset.
